(19) United States
(12) Patent Application Publication
(10) Pub. No.: US 2025/0303743 A1
(43) Pub. Date: Oct. 2, 2025

(54) PRINTING DEVICE, PRINTING METHOD, AND IMAGE PROCESSING METHOD

(71) Applicant: SEIKO EPSON CORPORATION, Tokyo (JP)

(72) Inventors: Toshiaki KAKUTANI, Shiojiri (JP); Hirotaka MATSUNAGA, Matsumoto (JP)

(21) Appl. No.: 19/087,689

(22) Filed: Mar. 24, 2025

(30) Foreign Application Priority Data
Mar. 26, 2024 (JP) 2024-048843

(51) Int. Cl. B41J 2/21; B41J 2/045; B41J 11/00; G06K 15/02; G06K 15/10

(52) U.S. Cl. CPC B41J 2/2128; B41J 2/04581; B41J 2/04588; B41J 2/04593; B41J 2/04596; B41J 2/04598; B41J 2/2103; B41J 11/008; G06K 15/102; G06K 15/1836; G06K 15/1871

(57) ABSTRACT

A printing device includes: a head including an ejection unit that ejects a liquid; a print position changing unit that changes a positional relationship between a medium and the head; a signal output unit that selectively outputs, to a drive element, a drive signal for ejecting the liquid; and a control unit that controls the print position changing unit and the signal output unit to control the ejection of the liquid. At an on-edge part where a dot-forming pixel comes next to a non-dot-forming pixel, the drive signal at a position corresponding to the non-dot-forming pixel is set to be a drive signal smaller than a signal corresponding to a maximum ejection capability that can be achieved at the dot-forming pixel and larger than a signal at the non-dot-forming pixel, and is thus output to the drive element.

The present application is based on, and claims priority from JP Application Serial Number 2024-048843, filed Mar. 26, 2024, the disclosure of which is hereby incorporated by reference herein in its entirety.

### BACKGROUND

### 1. Technical Field

The present disclosure relates to a printing technique of printing using liquid droplets and an image processing technique for performing printing using liquid droplets.

### 2. Related Art

A technique for performing printing by ejecting liquid droplets from a print head toward a medium is widely used. In a device performing such printing, the landing position of the liquid droplets on the medium needs to be precisely controlled in order to enhance the quality of an image to be formed. In the printing using liquid droplets, the types of tone values that can be expressed by a liquid droplet itself are much fewer than the tone values per pixel of an original image (for example, 256 tone levels). When large and small liquid droplets can be ejected, only three tone levels, that is, no dots, small dots, and large dots, are provided, and even when large, medium, and small droplets can be ejected, only four tone levels are provided. Therefore, in order to enhance the image quality of the image formed of ink dots, it is necessary that the distribution of the dots formed by liquid droplets is made appropriate by image processing such as half-toning and that the landing position on the medium reproduces the result of the image processing with high fidelity.

JP-A-2015-066772 and JP-A-2015-112825 are examples of the related art.

However, the landing position of the liquid droplets on the medium may deviate from design values due to various factors. For example, when the pressure in an ink chamber coupled to a nozzle is controlled using a piezo element or the like to eject a liquid droplet from the nozzle, residual vibration occurs in the ink pressure in the ink chamber and vibration or the like of the ink surface (meniscus) in the nozzle occurs for a while after the ejection of the liquid droplet. Since the amount of ejection and the ejection speed of the ink change depending on the timing of the next pressure control on the residual vibration of the pressure, the time until the liquid droplet flies across the gap to the medium and reaches the medium may not be constant in some cases. During the printing, since the medium moves relatively to the nozzle, the landing position of the liquid droplet changes when the time until the liquid droplet reaches the medium changes.

As described in JP-A-2015-066772 and JP-A-2015-112825, control such as increasing the amount of ink of liquid droplets to be ejected is performed using the timing of pressure control for the pressure vibration and the next ink droplet ejection, but depending on the image to be printed, there may be a case where the next ink droplet is ejected in the state where the pressure vibration remains, and a case where the next liquid droplet is ejected in the state where there is little pressure vibration. In such cases, the size and speed of the next liquid droplet to be ejected vary. A technique of generating a pressure change to an extent that causes micro-vibration of the meniscus is already proposed in order to cope with the variation of the liquid droplet at the edge of the image, but due to factors such as a constraint in that the micro-vibration is limited to a range that does not cause dot ejection, there is a large difference from the phase and amplitude size of the residual vibration after the dot is actually ejected, and therefore the difference in the size and speed of the liquid droplet cannot be solved, which may influence the image quality.

### SUMMARY

The present disclosure can be implemented according to the aspects or application examples given below.

(1) A printing device of the present disclosure can be implemented according to the following aspect. The printing device includes: a head including an ejection unit that ejects a liquid droplet and forms a dot on a medium in response to a drive element driven by a drive signal; a print position changing unit that changes a relative positional relationship between the medium and the head along a predetermined direction; a signal output unit that selectively outputs, to the drive element, the drive signal for ejecting the liquid droplet under ejection conditions with different ejection capabilities from the ejection unit; and a control unit that controls the print position changing unit and the signal output unit to control the ejection of the liquid droplet from the ejection unit toward the medium according to a dot-forming pixel and a non-dot-forming pixel arranged along the predetermined direction. At an on-edge part where the dot-forming pixel comes next to the non-dot-forming pixel along the predetermined direction, the drive signal at a position corresponding to the non-dot-forming pixel is set to be a drive signal smaller than a signal corresponding to a maximum ejection capability that can be achieved at the dot-forming pixel and larger than a signal at the non-dot-forming pixel, and is thus output to the drive element.

(2) A printing method of the present disclosure can be implemented according to the following aspect. The printing method includes: changing a relative positional relationship between a head including an ejection unit that ejects a liquid droplet and forms a dot on a medium in response to a drive element driven by a drive signal and the medium along a predetermined direction; outputting, to the drive element, a signal for ejecting the liquid droplet under different ejection conditions from the ejection unit, with the change in the positional relationship, and forming a dot based on the liquid droplet on the medium; and at an on-edge part where a dot-forming pixel at which the dot is generated comes next to a non-dot-forming pixel at which the dot is not formed on the medium, along the predetermined direction, setting the drive signal at a position corresponding to the non-dot-forming pixel to be a drive signal smaller than a signal corresponding to a maximum ejection capability that can be achieved at the dot-forming pixel and larger than a signal at the non-dot-forming pixel, and outputting this drive signal to the drive element.

(3) An image processing method of the present disclosure can be implemented according to the following aspect. The image processing method is for a printing device which changes a relative positional relationship between a head including an ejection unit that ejects a liquid droplet and forms a dot on a medium in response to a drive element driven by a drive signal and the medium along a predetermined direction, the method preparing dot data that defines whether to form the dot, the method including: inputting image data of an image to be reproduced on the medium; converting the image data into dot data formed by distributing dots corresponding to a number of tone levels that can be formed by the head; and modifying the dot data in such a way that, at an on-edge part where a dot-forming pixel at which the dot is formed comes next to a non-dot-forming pixel at which the dot is not formed in an array of the dots along the predetermined direction included in the dot data, a dot smaller than a largest dot that can be formed at the dot-forming pixel is formed at the non-dot-forming pixel.

### BRIEF DESCRIPTION OF THE DRAWINGS

FIG. 1 is a block diagram showing the configuration of an inkjet printer according to a first embodiment.

FIG. 2 is a schematic cross-sectional view of a main part of the inkjet printer.

FIG. 3 is a diagram illustrating the positional relationship between a head unit and a recording medium.

FIG. 4 is a schematic cross-sectional view of a main part of the head unit.

FIG. 5 is a diagram illustrating a change in the cross-sectional shape of an ejection unit when a drive signal is supplied.

FIG. 6 is a block diagram showing the configuration of a drive signal output unit.

FIG. 7 is a diagram illustrating the relationship between a print signal corresponding to dot data and the size of a liquid droplet.

FIG. 8 is a diagram illustrating the relationship between the print signal, the drive signal, and the size of the liquid droplet to be formed in a unit period.

FIG. 9 is a flowchart showing an example of an image processing routine.

FIG. 10 is a diagram illustrating how dots are formed at an on-edge part in the first embodiment.

FIG. 11 is a diagram illustrating how dots are formed at the on-edge part in a first modification example of the first embodiment.

FIG. 12 is a diagram illustrating how dots are formed at the on-edge part in a second modification example of the first embodiment.

FIG. 13 is a diagram illustrating how one raster is formed by liquid droplets from two nozzles in a second embodiment.

FIG. 14 is a diagram illustrating how dots are formed at the on-edge part in the second embodiment.

FIG. 15 is a block diagram illustrating the configuration of a drive signal output unit according to a third embodiment.

FIG. 16 is a diagram illustrating an example of a drive waveform signal in the third embodiment.

FIG. 17 is a diagram illustrating how dots are formed at the on-edge part in the third embodiment.

### DESCRIPTION OF EMBODIMENTS

### A. First Embodiment

(A1) Overall Hardware Configuration of Printing Device

In the present embodiment, an inkjet line printer that ejects ink (an example of “liquid droplets”) and thus forms an image on a medium P such as paper, cloth, or film will be described as an example of a printing device.

### 1. Configuration of Inkjet Printer

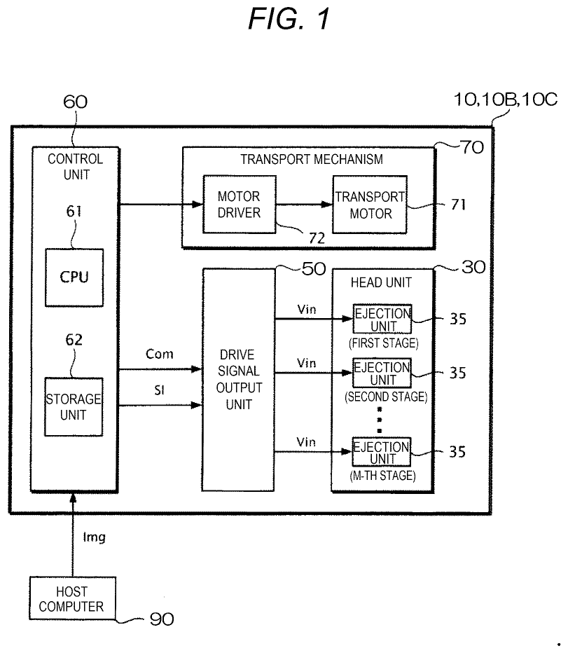

The configuration of an inkjet printer 10 according to the embodiment will now be described with reference to FIGS. 1 to 3. As shown in FIG. 1, the inkjet printer 10 includes a head unit 30, which is an example of a head, a drive signal output unit 50, which is an example of a signal output unit, a transport mechanism 70, which is an example of a print position changing unit, and a control unit 60.

The head unit 30 includes M ejection units 35, M being a natural number equal to or larger than four in the present embodiment. The drive signal output unit 50 generates and outputs a drive signal Vin for driving the head unit 30. The transport mechanism 70 changes the relative position of the medium P in relation to the head unit 30. The control unit 60 controls the operation of each unit of the inkjet printer 10 such as the head unit 30 and the drive signal output unit 50. The schematic configuration of such hardware is the same in the first to third embodiments, the reference signs of an inkjet printer 10B according to the second embodiment and an inkjet printer 10C according to the third embodiment are also given in FIG. 1. The differences between the inkjet printers 10B and 10C and the inkjet printer 10 will be described in the description of the embodiments.

In the description of these inkjet printers, in order to distinguish each of the M ejection units 35, the M ejection units 35 may be referred to as first stage, second stage, . . . , M-th stage in order. The inkjet printer 10 includes, for example, a display unit, an operation unit, and the like, but these members are not illustrated. The display unit is configured with a liquid crystal display, an organic EL display, an LED lamp, and the like, and displays the state of the inkjet printer 10, an instruction to the user, an error message, or the like. The operation unit includes various switches and the like for inputting an instruction of the user, and an operation panel having such switches and the like. The display unit may be configured to represent the content of the display by voice, and similarly, the operation unit may be configured to input an instruction, using voice recognition or the like. The display unit and the operation unit can be easily implemented by a mobile terminal such as a mobile phone or a computer that is wired or wirelessly connected.

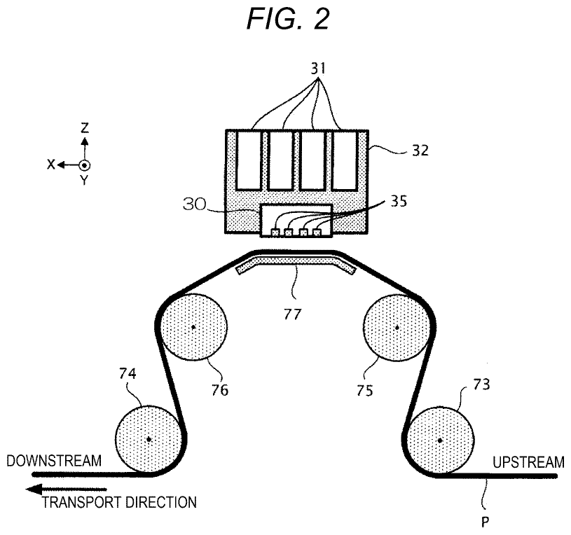

In the present embodiment, the inkjet printer 10 is a line printer, and ejects liquid droplets from the head unit 30 onto the medium P transported by the transport mechanism 70 and thus forms an image on the medium P. This state is schematically shown in FIG. 2. As indicated by arrows X, Y, and Z in the illustration, in the following description, the direction in which the medium P i transported is defined as X, the width direction of the medium P is defined as Y, and the direction orthogonal to the X direction and the Y direction is defined as Z. With respect to the X direction, the direction from upstream to downstream of the medium P is referred to as the +X direction, and with respect to the Y direction, the direction from the right side (the back side in the illustration) to the left side (the front side in the illustration) when the medium P is viewed in the +X direction is referred to as the +Y direction, and with respect to the Z direction, the direction from the medium P toward the head unit 30 in the Z direction is referred to as the +Z direction. The −X, −Y, and −Z directions are opposite to the +X, +Y, and +Z directions, respectively. These directions are shown also in other drawings as appropriate. Since the medium P moves in the +X direction in relation to the head unit 30, the liquid droplets ejected in the −Z direction from the head unit 30 toward the medium P land at a position shifted in the −X direction in relation to a position on the medium P which the head unit 30 faces at the ejection moment. The landing position shifts more significantly in the −x direction as the ejection speed of the liquid droplets becomes lower. The ink dots formed on the medium P are arrayed from downstream to upstream on the medium P as the printing progresses.

The transport mechanism 70 for transporting the medium P from upstream to downstream includes a transport motor 71 serving as a transport drive source, and a motor driver 72 for driving the transport motor 71. As shown in FIG. 2, the transport mechanism 70 includes a platen 77 provided below (in FIG. 2, in the −Z direction of) the head unit 30, transport rollers 73 and 74 rotating by the operation of the transport motor 71, and guide rollers 75 and 76 driven by the rotation of the transport rollers 73 and 74. The medium P is transported in the +X direction (from upstream to downstream) in the illustration, along a transport path defined by the transport roller 73, the guide roller 75, the platen 77, the guide roller 76, and the transport roller 74.

The inkjet printer 10 includes a carriage 32, and accommodates the head unit 30 including the M ejection units 35 in the carriage 32. The carriage 32 houses the drive signal output unit 50 (not shown in FIG. 2) and four ink cartridges 31 in addition to the head unit 30. The carriage 32 is disposed on the opposite side of the transport path of the medium P from the platen 77, that is, above (in the +Z direction of) the platen 77.

The four ink cartridges 31 are provided in one-to-one correspondence to the four colors of yellow, cyan, magenta, and black, and the ink cartridges 31 are filled with inks of the colors corresponding to the ink cartridges 31. Each of the M ejection units 35 receives the ink supplied from one of the four ink cartridges 31. Each of the ejection units 35 fills the inside thereof with the ink supplied from the ink cartridge 31 and ejects the ink filling the inside, as a liquid droplet toward the medium P. Thus, the inks of the four colors can be ejected from the M ejection units 35 as a whole, and full-color printing is implemented. The mechanism of ejection of the liquid droplets will be described later in detail.

The inkjet printer 10 according to the present embodiment has the four ink cartridges 31 corresponding to the inks of the four colors, but is not necessarily limited to four colors and may have three or fewer, or five or more ink cartridges 31 corresponding to three or fewer, or five or more colors. Further, the inkjet printer may have an ink cartridge 31 filled with an ink of a different color from the four colors or only an ink cartridge 31 corresponding to a part of the four colors. That is, the inkjet printer according to the present disclosure may simply need to be able to eject an ink of one or more colors from the ejection unit 35. Also, instead of being installed in the carriage 32, each ink cartridge 31 may be provided at another location in the inkjet printer 10 and may supply ink to each of the ejection units 35 in the head unit 30 via a tube or the like.

The timing of the transport of the medium P and the timing of the ejection of the liquid droplets from each of the ejection units 35 in the head unit 30 are controlled by the control unit 60. Under the control of the control unit 60, each of the ejection units 35 ejects ink onto the medium P at the timing when the medium P is transported to a desired position on the platen 77 by the transport mechanism 70, and thus forms an image on the medium P.

As shown in FIG. 1, the control unit 60 receives an input of image data Img of multiple tone levels, for example, 256 tone levels of each color from a host computer 90 such as a personal computer or a digital camera, performs halftone processing, controls the drive signal output unit 50 and the transport mechanism 70 or the like, and thus executes print processing of forming an image corresponding to the image data Img on the medium P. Specifically, the control unit 60 drives the transport motor 71 in such a way as to intermittently feed the medium P one by one in the transport direction (+X direction) via the control of the motor driver 72, and controls whether to eject ink from each ejection unit 35 and the ink ejection timing via the control of the drive signal output unit 50. Thus, the control unit 60 adjusts the arrangement of the ink dots formed of the ink ejected onto the medium P, and executes the print processing of forming the image corresponding to the image data Img on the medium P. Also, the control unit 60 may execute processing of transferring an error message or information of ejection abnormality or the like to the host computer 90 when necessary.

The control unit 60 has a CPU 61 and a storage unit 62. The storage unit 62 includes an EEPROM (electrically erasable programmable read-only memory), which is a kind of a nonvolatile semiconductor memory that stores, in a data storage area, the image data Img supplied from the host computer 90 via an interface unit, not illustrated, a RAM (random access memory) that temporarily stores necessary data to execute various kinds of processing such as print processing or is temporarily loaded with a control program for executing various kinds of processing such as print processing, and a PROM, which is a kind of a nonvolatile semiconductor memory that stores the control program for controlling the each unit in the inkjet printer 10.

The CPU 61 receives the input of the image data Img supplied from the host computer 90, performs halftone processing on the image data Img, and converts the image data Img to data about whether to form ink dots with liquid droplets, that is, dot data. The dot data, which is the result of the halftone processing, is stored in the storage unit 62. The halftone processing is binarization to define whether to form ink dots when there is only one size of ink dots that can be formed with liquid droplets ejected by each ejection unit 35, 3-value conversion to define whether to form no ink dots, small ink dots, or large ink dots when ink dots can be formed in the two sizes of small and large, and 4-value conversion to define whether to form no ink dots, small ink dots, medium ink dots, or large ink dots when ink dots can be formed in the three sizes of small, medium, and large. When light-colored ink such as ink of light magenta or light cyan is contained in the ink cartridge 31, halftone processing with larger number of tone levels can be performed. In the present embodiment, as will be described later, each of the ejection units 35 can form the three types of dots, that is, in small, medium, and large sizes, and the control unit 60 performs 4-value conversion. Also, the halftone processing such as 4-value conversion may be performed on the side of the host computer 90, and the inkjet printer 10 may receive and print dot data from the host computer 90.

The CPU 61 of the control unit 60 generates signals such as a print signal SI and a drive waveform signal Com for controlling the operation of the drive signal output unit 50 to drive each ejection unit 35, based on the various data such as the image data Img stored in the storage unit 62, and also generates various signals such as a control signal for controlling the operation of the motor driver 72, based on the various data stored in storage unit 62, and outputs the generated various signals. In this way, the control unit 60 (CPU 61) generates the various signals such as the print signal SI and the drive waveform signal Com, supplies the signals to each unit in the inkjet printer 10, and thus comprehensively controls the operation of each unit in the inkjet printer 10. Thus, various kinds of processing such as print processing are implemented.

The drive signal output unit 50 generates a drive signal Vin for driving each of the M ejection units 35 provided in the head unit 30, based on the print signal SI and the drive waveform signal Com supplied from the control unit 60.

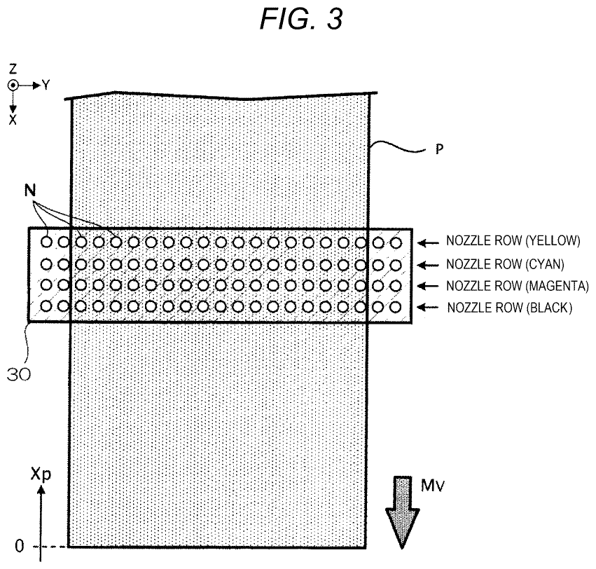

FIG. 3 is a diagram schematically showing the positional relationship between the medium P and the head unit 30 when the inkjet printer 10 is viewed in a plan view, that is, when the inkjet printer 10 is viewed in the −Z direction from above. Since the inkjet printer 10 is a line printer, the width of the head unit 30 in the Y direction is larger than the width of the medium P. As illustrated, the head unit 30 has four nozzle rows, each including a plurality of nozzles N extending in the lateral direction (Y-axis direction). Yellow (Y) liquid droplets are ejected from each nozzle N provided in the first nozzle row, of the four nozzle rows, magenta (M) liquid droplets are ejected from each nozzle N provided in the second nozzle row, cyan (C) liquid droplets are ejected from each nozzle N provided in the third nozzle row, and black (K) liquid droplets are ejected from each nozzle N provided in the fourth nozzle row.

The pitch between the nozzles N provided in each nozzle row can be appropriately set according to the print resolution (dots per inch or dpi). The print resolution of the inkjet printer 10 according to the present embodiment is 720×720 dpi. The resolution in the Y direction of the inkjet printer 10 depends on the configuration of the head unit 30, specifically, the interval in the Y direction of the arrangement of the nozzles N, and the resolution in the X direction depends on the ejection interval of liquid droplets from the ejection unit 35 and the transport speed of the medium P by the transport mechanism 70. These elements can be freely set, based on the design of the inkjet printer 10.

In the present embodiment, the plurality of nozzles N forming each nozzle row are arranged in such a way as to be aligned in one row in the Y-axis direction, but the positions of the nozzles N with even ordinal numbers and the nozzles with odd ordinal numbers from the left in the illustration, of the plurality of nozzles N forming each nozzle row, may be arranged in a so-called zigzag form by shifting the stage in the X-axis direction. Also, in the present embodiment, the arrangement direction of the nozzle rows coincides with the Y-axis direction, but the direction of the nozzle rows may have an angle such as 30 degrees to the Y-axis direction.

In FIG. 3, when the inkjet printer 10 executes the print processing, the medium P is transported in the downward direction (+X direction) in the illustration at a predetermined transport speed Mv by the transport mechanism 70. The transporting speed Mv (print speed) of the inkjet printer 10 according to the present embodiment is “220 m/min” or higher. As liquid droplets are ejected from the nozzles N of the head unit 30 to form ink dots on the medium P while the medium P is transported, an image is recorded on the medium P. That is, the image is recorded as a set of ink dots formed by liquid droplets ejected from the nozzles N arranged at the print resolution in the Y direction. When focusing on one nozzle N, ink dots formed by liquid droplets ejected from the nozzles are arrayed in the X direction of the medium P. Therefore, in this line printer, the array of ink dots along the transport direction of the medium P is called a “raster”. The position of an ink dot on the raster may be referred to as a position on the medium Xp.

### (A2) Configuration of Head Unit

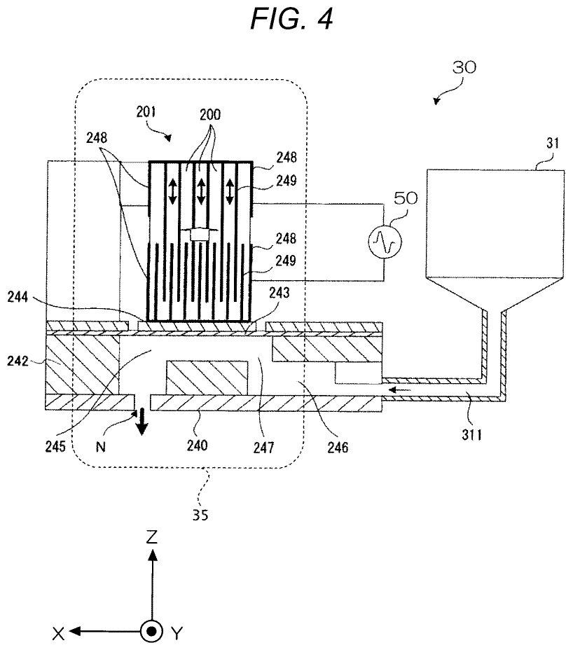

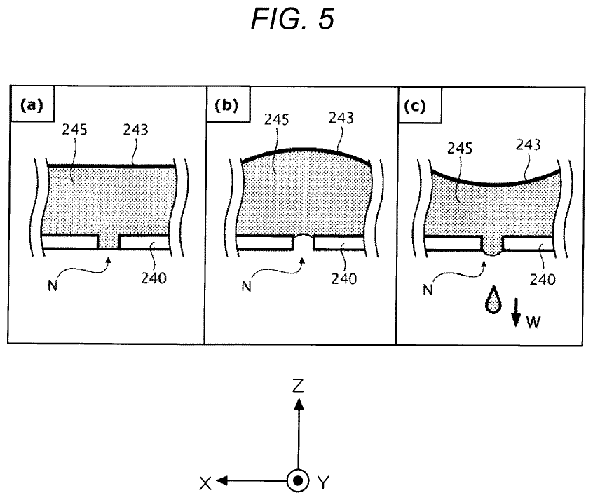

The structure of the head unit 30 including the ejection unit 35 and the ink ejection operation of the ejection unit 35 will be described with reference to FIGS. 4 and 5. In FIG. 4, for the sake of convenience of illustration, the structure of the head unit 30 and the ink cartridge 31 is shown, using one ejection unit 35 of the M ejection units 35 provided in the head unit 30, and a reservoir 246 communicating with the ejection unit 35 via an ink supply port 247.

As illustrated, the ejection unit 35 includes a multilayer piezoelectric element 201 made up of a plurality of piezoelectric elements 200 stacked together, a cavity 245 filled with ink inside, the nozzle N communicating with the cavity 245, and a diaphragm 243. Since the piezoelectric element 200 is driven by the drive signal Vin, the ejection unit 35 ejects liquid droplets from the nozzle N, using a volume change of the multilayer piezoelectric element 201 acting as a drive element and a pressure change in the cavity 245 associated therewith.

The cavity 245 of the ejection unit 35 is a space demarcated by a cavity plate 242 formed in a predetermined shape with a concave part, a nozzle plate 240 where the nozzles N are formed, and the diaphragm 243. The cavity 245 communicates with the reservoir 246, which is a space demarcated by the cavity plate 242 and the nozzle plate 240, via the ink supply port 247. The reservoir 246 communicates with the ink cartridge 31 via an ink supply tube 311.

The lower end of the multilayer piezoelectric element 201 is joined to the diaphragm 243 via an intermediate layer 244. A plurality of external electrodes 248 and internal electrodes 249 are joined to the multilayer piezoelectric element 201. That is, the external electrodes 248 are joined to the outer surface of the multilayer piezoelectric element 201, and the internal electrodes 249 are arranged between the piezoelectric elements 200 (or inside the piezoelectric elements) forming the multilayer piezoelectric element 201. More specifically, some of the external electrodes 248 and the internal electrodes 249 are alternately arranged in such a way as to be stacked in the thickness direction of the piezoelectric element 200.

As the drive signal Vin is supplied between the external electrode 248 and the internal electrode 249 from the drive signal output unit 50, the multilayer piezoelectric element 201 expands and contracts along the Z direction as indicated by arrows, and with this expansion and contraction, the diaphragm 243 expands and contracts. With the expansion and contraction of the diaphragm 243, the volume of the cavity 245 and hence the pressure in the cavity 245 change, and the ink filling the inside of the cavity 245 is ejected as liquid droplets from the nozzle N. When the amount of ink in the cavity 245 is reduced by the ejection of liquid droplets, the ink is supplied from the reservoir 246. Also, the ink is supplied to the reservoir 246 from the ink cartridge 31 through the ink supply tube 311. When continuously ejecting liquid droplets, the drive signal Vin is repeatedly supplied to the piezoelectric element 200 and therefore the multilayer piezoelectric element 201 apparently vibrates in accordance with the repetition frequency.

When the drive signal Vin is output from the drive signal output unit 50 to the piezoelectric element 200, an electric field is generated between the electrodes by the voltage applied between the electrodes, and a distortion proportional to the intensity of the electric field is generated. Thus, the diaphragm 243 flexes in the Z direction from the initial state illustrated in the column (a) in FIG. 5, and the volume of the cavity 245 increases as illustrated in the column (b) in FIG. 5. In this state, when the voltage indicated by the drive signal Vin is changed by the control of the drive signal output unit 50, the diaphragm 243 is restored by the elastic restoring force thereof and moves in the −Z direction beyond the position of the diaphragm 243 in the initial state, and the volume of the cavity 245 suddenly decreases as illustrated in the column (c) in FIG. 5. At this time, a part of the ink filling the cavity 245 is ejected as a liquid droplet from the nozzle N communicating with the cavity 245 by a compression pressure generated in the cavity 245.

After the series of ink ejection operations is completed, vibration remains in the diaphragm 243 of each cavity 245 for a certain period of time. Since the vibration is damped with time, this is referred to as damped vibration or residual vibration. The residual vibration of the ink pressure has a natural frequency determined by the acoustic resistance based on the shape of the nozzle N or the ink supply port 247 or based on the ink viscosity or the like, the inertance based on the ink weight in the flow path, and the compliance of the diaphragm 243. Although this vibration is damped with time, the vibration is replaced by new vibration when the next ink ejection operation is started even in the state where vibration remains. At this time, depending on the relationship between the phase of the residual vibration and the phase of the pressure vibration applied by the next ejection operation, the ejection performance of the next ejection operation, specifically, the size and the ejection speed of the ejected liquid droplets vary. This point will be described in detail in a second embodiment.

### (A3) Drive Signal of Drive Element

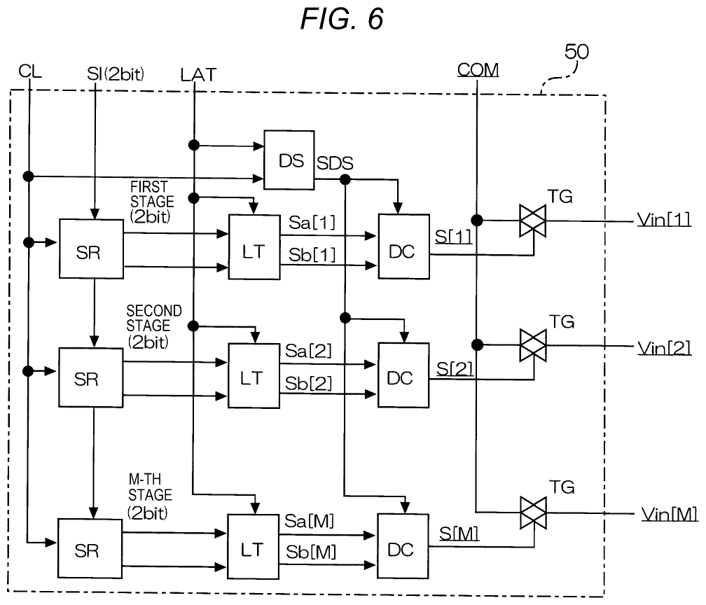

The configuration and operation of the drive signal output unit 50 will now be described with reference to FIGS. 6 to 12. As shown in FIG. 6, which is a block diagram showing the configuration of the drive signal output unit 50, the drive signal output unit 50 includes M shift register SR, M latch circuits LT, and M decoders DC, M being an integer equal to or greater than 1. The drive signal output unit 50 also includes one switching instruction unit DS. The shift register SR, the latch circuit LT, and the decoder DC form a set to input an output from the preceding stage to the subsequent stage in this order, and the elements forming the M sets may be referred to as the first stage, the second stage, the M-th stage in order from the top in the illustration.

Prior to the description of the operation of each part, the flow of signals will be briefly described. A clock signal CL, a latch signal LAT, a print signal SI, and a drive waveform signal COM are supplied to the drive signal output unit 50 from the control unit 60. The print signal SI is a 2-bit signal that prescribes whether to eject liquid droplets from each ejection unit 35 (each nozzle N), and that prescribes the size of liquid droplets (small, medium, or large) when liquid droplets are to be ejected, in forming one dot of an image. The print signal SI is supplied serially from the control unit 60 to the drive signal output unit 50 by two bits each, in synchronization with the clock signal CL. After the M print signals SI corresponding to the M ejection units 35 are serially transferred, the latch signal LAT is sent from the control unit 60 and the print signal SI corresponding to the M ejection units 35 is latched by the M latch circuits LT. Subsequently, with the output of the drive waveform signal COM, a switching signal SDS is output from the switching instruction unit DS, and the M drive signals Vin are output from the drive signal output unit 50 toward the corresponding ejection unit 35.

Each of the shift registers SR can replace 2-bit serial data with parallel data output. The M shift registers SR are cascaded, and on receiving 2×M serial data in synchronization with the clock signal CL, the shift registers SR are in the state of outputting the input serial data as 2×M parallel data. Each of the latch circuits LT latches the output from the shift register SR by two bits each, at the timing when the latch signal LAT is received.

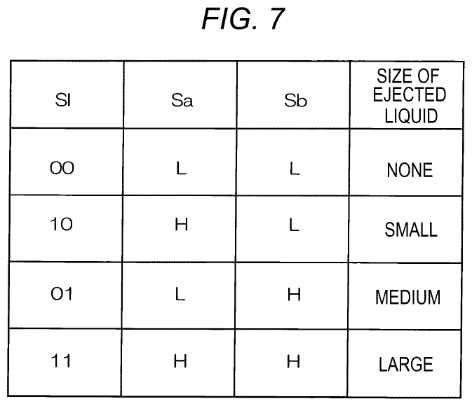

The 2-bit outputs from the latch circuits LT of the first to M-th stages are expressed as Sa [1], Sb [1], . . . , Sa [M], Sb [M]. The print signal SI, which the shift register SR collectively receives by two bits each, is dot data designating the formation of dots, in which the lower bit corresponds to the latch output Sa and the upper bit corresponds to the latch output Sb. The latch outputs Sa, Sb correspond to the on and off of a selection signal S output from the decoder DC and hence the size of the ejected liquid droplets. The relationship between these elements is shown in FIG. 7. The size of the liquid droplets corresponds to the size of dots actually formed on the medium P. As the content of the two bits forming the print signal SI, “00” corresponds to formation of no dots, “10” corresponds to formation of small dots, “01” corresponds to formation of medium dots, and “11” corresponds to formation of large dots. In the present specification, when conditions such as the time interval from the previous ejection are the same, a drive waveform for ejecting dots of a larger size is represented as a larger drive signal, and when the ejection of dots is not achieved, a drive waveform for causing greater meniscus vibration is represented as a larger drive signal. To eject dots of a larger size, techniques such as increasing the amplitude of the waveform, increasing the cycle of the waveform, and increasing the number of drive waveforms, are used. The actual amount of ejected ink is influenced not only by the drive signal but also by the time interval from the previous ejection, or the like.

The selection signal S, which is the output from the decoder DC, is coupled to a gate terminal of the transmission gate TG. The same drive waveform signal COM is input to the transmission gate TG of each stage. The drive waveform signal COM includes a first waveform FW1 for ejecting liquid droplets corresponding to small dots and a second waveform FW2 for ejecting liquid droplets corresponding to medium dots. The output from the transmission gate TG is controlled along the time axis, based on the selection signal S output by the decoder DC. The selection signal S changes in synchronization with the switching signal SDS output from the switching instruction unit DS after the output of the latch signal LAT in accordance with the contents of the latch outputs Sa and Sb. Specifically, after the output of the latch signal LAT, the latch output Sa determines whether to output the first waveform FW1, which is the first half of the drive waveform signal COM, as the drive signal Vin via the transmission gate TG. The latch output Sb determines whether to output the second waveform FW2, which is the second half of the drive waveform signal COM, as the drive signal Vin via the transmission gate TG.

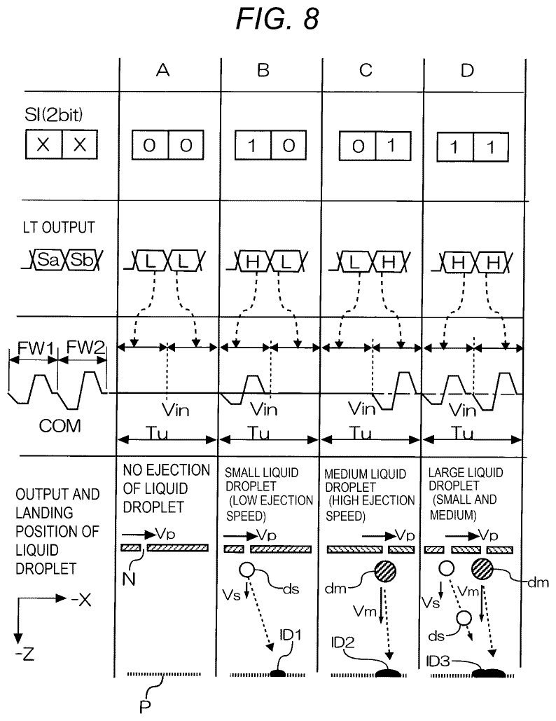

FIG. 8 illustrates the relationship between the print signal SI, the drive signal Vin, and the size of liquid droplets to be formed, in a unit period Tu. FIG. 8 is a diagram illustrating the print signal SI, the output from the latch circuit LT, the drive waveform signal COM, the output of the liquid droplet, and the landing position, in four cases A to D. A column A schematically shows a case where liquid droplets are not ejected and therefore ink dots are not formed, a column B schematically shows a case where small ink dots are formed, a column C schematically shows a case where medium ink dots are formed, and a column D schematically shows a case where large ink dots are formed. As illustrated, the drive waveform signal COM includes two signal waveforms for ejecting the liquid droplet shown in FIG. 5 in such a way as to be continuous along the time axis. Of two signal waveforms, the signal waveform preceding in time is the first waveform FW1 for ejecting liquid droplets forming small dots. The signal waveform subsequent to the first waveform FW1 is the second waveform FW2 for ejecting liquid droplets forming medium dots. Although a detailed description of the difference between the first waveform FW1 and the second waveform FW2 is omitted, a small liquid droplet is ejected, based on the first waveform FW1, and a medium liquid droplet is ejected, based on the second waveform FW2, due to the difference in the speed of pulling up the meniscus in the Z direction (column (b) in FIG. 5) and the strength at which the liquid droplet is pushed out (column (c) in FIG. 5) or the like.

As shown in FIG. 8, the print signal SI is a signal for designating which one of the first waveform FW1 and the second waveform FW2 is to be used or whether to use both. A small liquid droplet is ejected in the direction of the medium P (−Z direction) at a speed Vs, based on the first waveform FW1, and a medium liquid droplet is ejected in the direction of the medium P at a speed Vm, based on the second waveform FW2. The ejection speed Vs of the small liquid droplet is lower than the ejection speed Vm of the medium liquid droplet. The first waveform FW1 and the second waveform FW2 are next to each other in time, during which the medium P is transported in the X direction and the head unit 30 moves relatively to the medium P at a speed Vp. Thus, as shown in the lowermost part of FIG. 8, a small liquid droplet ds ejected at the speed Vs from the nozzle N toward the medium P and a medium liquid droplet dm ejected at the speed Vm, where Vm>Vs, apparently fly in the direction of combination with the relative moving speed Vp of the head unit 30 and land on the medium P to form ink dots ID1, ID2. The landing positions, that is, the formation positions of the ink dots ID1, ID2, are positions moved in the −X direction as viewed from the position faced by the nozzle N when the liquid droplets are ejected from the nozzle N. As shown in the column B and the column C, since it takes time until the liquid droplets reach the medium P, and the medium P is transported during that time, the landing positions on the medium P of the liquid droplet ds ejected at the speed Vs and the medium liquid droplet dm ejected at the speed Vm are close to each other despite the different timings of ejection. As shown in the column D, when both the first waveform FW1 and the second waveform FW2 are output, the small liquid droplet dm ejected at the speed Vs earlier is combined with the medium liquid droplet dm ejected at the speed Vm later, and an ink dot ID3 on the medium P is larger than either one of the ink dots ID1, ID2 formed, based on only the first waveform FW1 or only the second waveform FW2.

Which one of the first waveform FW1 and the second waveform FW2 is enabled or whether both are enabled is determined based on the print signal SI. That is, as whether to eject the small liquid droplets and medium liquid droplets from each ejection unit 35 in the head unit 30 is controlled based on the print signal SI, the four tone levels of no ink dot, small dot, medium dot, and large dot can be expressed for each dot on the medium P.

### (A4) Content of Image Processing

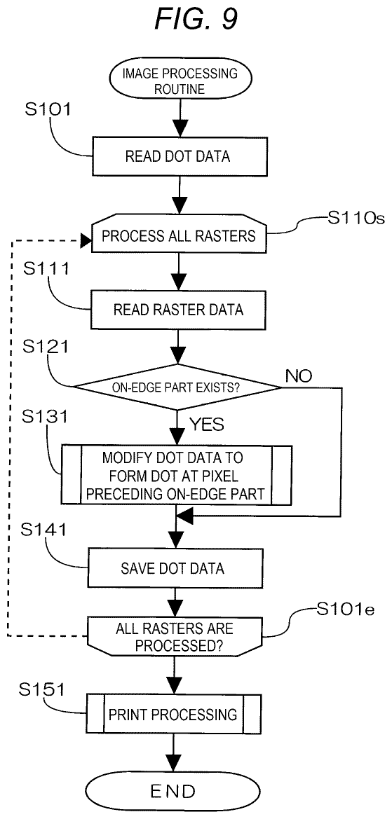

The content of image processing performed by the inkjet printer 10 will now be described. FIG. 9 is a flowchart showing an example of an image processing routine executed by the control unit 60 of the inkjet printer 10. In the present embodiment, dot data is transmitted from the host computer 90 to the inkjet printer 10. The host computer 90 performs halftone processing on image data of an image to be printed into the four tone levels with respect to each of the four colors of CMYK with a printer driver for the inkjet printer 10, and transmits dot data directly corresponding to the formation of dots as the result of the halftone processing, to the inkjet printer 10 together with a print instruction. The inkjet printer 10 receives the dot data of the image to be printed from the host computer 90, stores the dot data in the storage unit 62, and then starts the image processing routine shown in FIG. 9. Also, the host computer 90 may transmit the image data to the control unit 60 and the control unit 60 may perform processing of converting the image data into dot data.

Upon starting the illustrated image processing routine, the inkjet printer 10 first performs processing of reading the dot data received from the host computer 90 and stored in the storage unit 62 (step S101). At this time, the dot data is read in the order along the rasters for each nozzle N. The processing of steps S111 to S141 involved in the reading of the dot data is repeated until the reading of the data for all the rasters is completed (steps S110s to S110e).

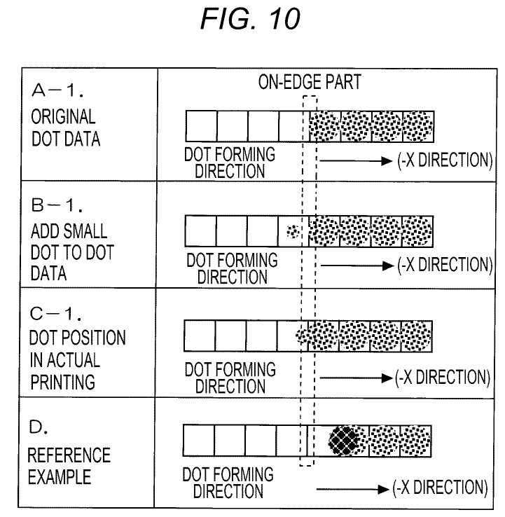

In the repeated processing, first, the array of dot data for the focused raster (hereinafter referred to as raster data) is read (step S111), and whether there is an on-edge part in the raster data (step S121). The on-edge part refers to a site where a pixel at which a dot is formed is arranged after an array of one or more pixels at which a dot is not formed, in the raster data. An example of the on-edge part is shown in a section A-1 in FIG. 10. In the illustrated example, in raster data in which eight pixels are arranged, four pixels at which a dot is not formed are arranged along the dot forming direction, and subsequently four pixels at which a large dot is formed are arranged next to each other. In this case, the boundary between the fourth pixel, at which a dot is not formed, and the fifth pixel, at which a dot is formed, is the on-edge part. In the illustration, the dots to be formed are drawn in such a way as to be inscribed in the pixels in order to facilitate understanding, but the actual large dots may be formed to be larger than those inscribed in the pixels so that the ground color (normally, white) of the medium P is not left when all the pixels are filled.

When it is determined in step S121 that there is an on-edge part (YES in step S121), the dot data is modified to form a dot at the pixel preceding the on-edge part (step S131). Meanwhile, when it is determined that there is no on-edge part (NO in step S121), the processing proceeds to step S141 without performing the processing of step S131. The dot formed at the pixel preceding the on-edge part may be, for example, a small dot, as shown in a section B-1 in FIG. 10.

After the dot data is modified so that the raster is formed by the newly formed dot, the dot data is saved (step S141). The above processing is repeated for all the raster data, and when the processing for all the raster data is completed (step S110e), the print processing is performed using the modified dot data (step S151). When the printing is finished, the processing goes to “END” and this processing routine ends.

In the dot data after the above processing is performed, a modification is made in such a way that a small dot is formed at the pixel immediately before the on-edge part in the dot data transmitted from the host computer 90, that is, the pixel at which originally a dot should not be formed, as shown in the section B-1 in FIG. 10. When the control unit 60 controls the drive signal output unit 50 in accordance with the modified dot data so as to eject small liquid droplets from the corresponding ejection unit 35, the ejection of the liquid droplets corresponding to the small dot may be delayed from the original ejection timing or may drop in the ejection speed due to the absence of residual vibration, at each nozzle N having no ejection of liquid droplets for a while before the on-edge part. In such cases, since the landing position of the small liquid droplet on the medium P is shifted in the −X direction, the actually formed ink dot may be shifted to the rear of the on-edge part, that is, in the direction of the region where dots are formed, as shown in a section C-1 in FIG. 10. When the landing position is shifted in the −X direction, the small dot is formed at a position closer to the pixel on the rear side, at which a dot is originally supposed to be formed, and therefore the appearance of the formed dot hardly matters.

A supplementary explanation of the reason why the forming position of the small dot is shifted is given below. In the inkjet printer 10 according to the present embodiment, the drive waveform signal COM is applied to drive the multilayer piezoelectric element 201 of the ejection unit 35, and the pressure in the cavity 245 is thus changed to eject liquid droplets from the nozzle N. When liquid droplets are ejected from the nozzle N, the meniscus of the ink in the nozzle N returns to the original state, but in practice, residual vibration remains in the ink inside the cavity 245. The residual vibration is a damped vibration that is damped with time, but when the liquid droplets are consecutively ejected at a high speed, the residual vibration influences the change in the pressure in the cavity 245 based on the next drive waveform signal COM.

In the present embodiment, the waveform of the drive waveform signal COM is designed in such a way that, in the consecutive ejection of liquid droplets, the residual vibration from the ejection of the liquid droplet coincides with the timing of accelerating the ejection of the next liquid droplet. Therefore, an ejection speed Ve in the case of not ejecting liquid droplets at the preceding pixel but ejecting liquid droplets at the next pixel, as in the on-edge part, is lower than an ejection speed Vc of liquid droplets in the case of ejecting ink droplets consecutively at two pixels, due to the absence of an auxiliary force by the residual vibration. As a result, the speed of the liquid droplets at the on-edge part becomes slow, and the landing position may shift in the −X direction and overlap with the next pixel.

For these reasons, when the image processing illustrated in FIG. 9 is not performed, at the on-edge part, the first liquid droplet to be ejected after the period during which liquid droplets are not ejected may be ejected from the nozzle N at a low ejection speed and the landing position of the liquid droplet may shift to the rear, as shown as a “Reference Example” in a column D in FIG. 10. When such a phenomenon occurs, the position of the on-edge part shifts from the original position and becomes later in time and in the −X direction in terms of the transport direction of the medium P, resulting in a drop in the quality of the image to be printed.

In contrast, in the inkjet printer 10 according to the embodiment, where the image processing is performed, a small dot is formed at the pixel preceding the on-edge part, and though the print position of the small dot is close to the dot-forming pixel side immediately after the on-edge part (see the section C-1), the situation where the position of the dot formed at the pixel immediately after the on-edge part shifts from the original dot forming position due to the residual vibration generated by the formation of the small dot is suppressed and the image quality of the image is maintained. In addition, since the forming position of the small dot is close to the on-edge part side, the change in the image quality is suppressed in that regard as well. Also, even if the small dot is formed near the center of the pixel preceding the on-edge part, the small dot is small and therefore less conspicuous. Also, since the present embodiment can be implemented simply by rewriting the no-dot data of the on-edge part with the existing small dot data, there is no need for tasks such as switching the drive waveform signal COM to generate a new waveform in order to prevent the deterioration in the image quality at the on-edge part.

### (A5) Modification Examples of Image Processing

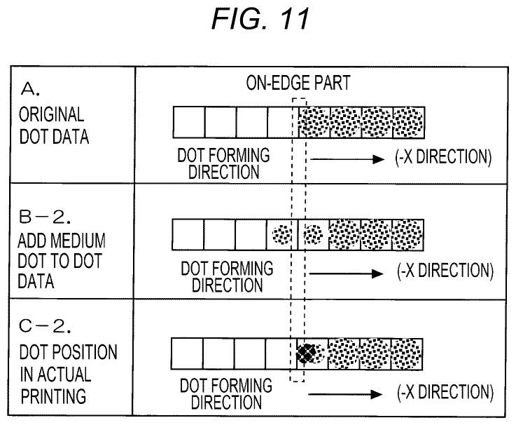

In the image processing in the above-described embodiment, a small dot is formed at the pixel preceding the on-edge part, but a small dot or a medium dot may be formed at the pixel preceding the on-edge part, and the dot formed at the pixel immediately after the on-edge part may be changed to a dot smaller than the original dot. This example is shown in FIG. 11 as a first modification example of the first embodiment. When a large dot is supposed to be formed at the pixel immediately after the on-edge part in the original dot data as shown in a column A in the illustration, a medium dot may be formed at the pixel preceding the on-edge part and a medium dot may be formed at the pixel immediately after the on-edge part as shown in a column B-2 in the illustration. In this case, since the actual forming position of the dot formed at the pixel preceding the on-edge part is likely to shift in the direction of the pixel immediately after the on-edge part, and at the pixel immediately after the on-edge part, the dot is formed at the normal position, utilizing the residual vibration, a print result as shown in a section C-2 in the illustration is more likely to be obtained. As a result, the change in the position of the on-edge part is small, and the deterioration in the image quality of the image is suppressed.

In addition, the increase in the density (tone value) of the entire image by adding the formation of the medium dot to the dot data is canceled by changing the large dot formed at the pixel immediately after the on-edge part to the medium dot. Thus, the change in the density of the entire image to be printed is suppressed.

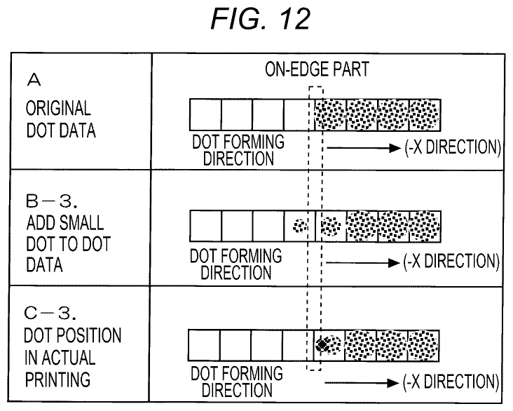

Similarly, a small dot may be formed at the pixel preceding the on-edge part, and the dot formed at the pixel immediately after the on-edge part may be changed to a medium dot. This example is shown in FIG. 12 as a second modification example of the first embodiment. When a large dot is supposed to be formed at the pixel immediately after the on-edge part in the original dot data as shown in a column A in the illustration, a small dot may be formed at the pixel preceding the on-edge part and a medium dot may be formed at the pixel immediately after the on-edge part as shown in a column B-3 in the illustration. In this case, since the actual forming position of the dot formed at the pixel preceding the on-edge part is likely to shift in the direction of the pixel immediately after the on-edge part, and at the pixel immediately after the on-edge part, the dot is formed at the normal position, utilizing the residual vibration, a print result as shown in a section C-3 in the illustration is more likely to be obtained. As a result, the change in the position of the on-edge part is small, and the deterioration in the image quality of the image is suppressed. This modification example, too, can be implemented simply by rewriting the large dot data of the on-edge part with the existing medium dot data, and therefore does not need the switching of the drive waveform signal COM or the like.

In this example, since the dot formed at the pixel immediately before the on-edge part is a small dot, there is little influence on the density of the entire image, and the increase in the density (tone value) of the entire image by adding the formation of the small dot to the dot data is canceled by changing the large dot formed at the pixel immediately after the on-edge part to the medium dot. Thus, the change in the density of the entire image to be printed and the deterioration in the image quality are suppressed.

### B. Second Embodiment

In the inkjet printer 10 according to the first embodiment, the head unit 30 is provided with the four nozzle rows of CMYK, as shown in FIG. 3, but in contrast, the inkjet printer 10B according to the second embodiment is a monochrome printer, in which the first and third rows of the four nozzle rows are supplied with ink of real black K1 and able to eject black liquid droplets whereas the second and fourth rows are supplied with ink of gray K2 and able to eject gray liquid droplets. The gray K2 ink is an ink having a black density approximately a quarter of that of the real black K1 ink. The other hardware configurations of the inkjet printer 10B are the same as those of the first embodiment and therefore the detailed description thereof is omitted.

For the sake of convenience of description, a case where the inkjet printer 10B prints only with the real black K1 ink will now be described as an example. The inkjet printer 10B performs monochrome printing at a high speed, using the real black K1 ink, and the reason for being able to print at a high speed is that, by using two nozzle rows, liquid droplets can be ejected toward the medium P apparently at a frequency twice the ejection frequency (frequency) of liquid droplets from one nozzle N. If liquid droplets of the real black K1 ink can be ejected from all the nozzle rows without using the gray K2 ink, the ejection frequency can be increased up to the maximum of four times with the nozzle arrangement shown in FIG. 3.

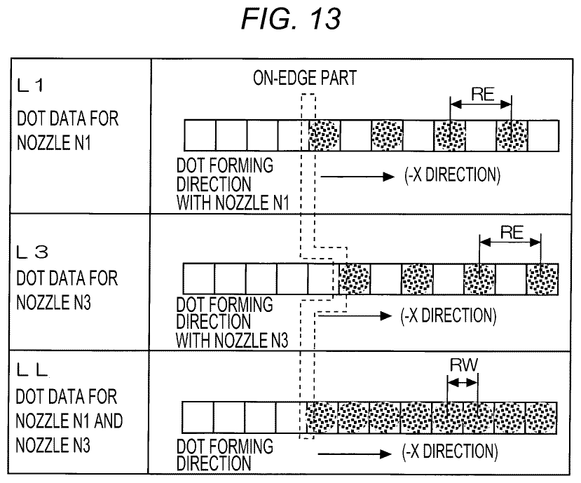

FIG. 13 shows a case where one raster is printed with two nozzles. As shown in a section L1 in the illustration, from nozzles N1 in the first row, liquid droplets are ejected to every other pixel forming the raster. At this time, the interval between the liquid droplets formed by the nozzles N1 is RE (mm). Meanwhile, as shown in a section L3 in the illustration, liquid droplets are ejected from nozzles N3 in the third row to the pixels where the nozzles N1 do not eject liquid droplets. At this time, again, the interval between the liquid droplets formed by the nozzles N3 is RE (mm). As a result, dots are formed on the raster at an interval RW, which is half the interval RE, on the medium P transported at a high speed. When the resolution is defined by the number of dots formed per unit distance (for example, 1 inch), the resolution of dots formed by the nozzles N1 and N3 is 25.4/RE (dpi), and the resolution of the raster is 25.4/RW (dpi). Thus, the resolution is doubled.

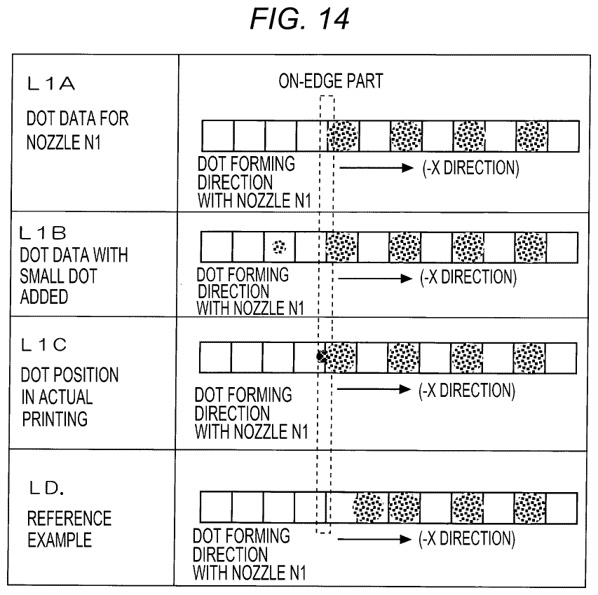

As described above, in the inkjet printer 10B according to the second embodiment, liquid droplets ejected from the plurality of nozzles are combined to form one raster. FIG. 14 shows the state of image processing and an example of actually formed dots in this case. In the image processing routine, an on-edge part existing in dot data formed for each nozzle is searched for, and the dot data is modified in such a way that a small dot is formed at the pixel preceding the on-edge part, as in the first embodiment. The dot data modified to add a small dot is shown as an example in a section LIB in the illustration. The state in which liquid droplets are ejected, using this dot data, is shown in a section LIC. In the illustration, where the on-edge part is indicated by a dashed line, each dot is formed every other pixel when viewed in terms of the pixels forming the raster, and therefore the pixel preceding the on-edge part is not the adjacent pixel but is a preceding pixel that is one pixel apart from the on-edge part.

When the control unit 60 drives the ejection unit 35 via the drive signal output unit 50 to eject a small liquid droplet before the on-edge part, residual vibration is not left and therefore the ejection timing of the liquid droplet is delayed and the forming position of the small dot shifts in the −X direction, described in the first embodiment. Although the degree of the shift is similar to that of the first embodiment, the landing position is a position further shifted in-X direction beyond the adjacent pixel. This is because, as long as the resolution of the dots forming the raster is the same as that of the first embodiment, the moving speed of the medium P is doubled, and therefore the medium P moves at a speed twice that of the first embodiment, that is, to a position at a distance twice that of the first embodiment, before the liquid droplet corresponding to the small dot ejected from the nozzle N1 reaches the medium P.

As for the dot formed at the pixel immediately after the on-edge part, since the small liquid droplet is ejected immediately before, residual vibration remains and therefore the ejection is performed normally and the landing position of the liquid droplet substantially coincides with the planned pixel. Similar image processing is performed for the nozzle N3 as well, and a small liquid droplet corresponding to a small dot is formed at the pixel preceding the on-edge part. In this way, the problem of a delay in the dot formation at the on-edge part, causing a shift in the position of the on-edge part, does not occur, or the generation of a shift is suppressed. A section LD in the illustration shows the state of raster formation when a dot is not formed at the pixel preceding the on-edge part. Since the forming positions of dots from the nozzles N1 and N3 shift in the −X direction from the on-edge part, the reproducibility of the position of the on-edge part drops and the image quality tends to be deteriorated.

In FIG. 13, the position of the on-edge part is shown in connection with both the arrangements of dots formed by the nozzles N1 and N3. However, in the completed raster, before the pixel where the dot is formed by the liquid droplet ejected from one nozzle (in this example, the nozzle N3), the dot formed by the liquid droplet ejected from the other nozzle (in this example, the nozzle N1) is present, and therefore this side is regarded as having no on-edge part. As described above, the adjacent pixels used for the determination of the on-edge part in the present disclosure are not adjacent pixels in the completed raster but adjacent pixels in terms of the pixels formed by one nozzle.

In the second embodiment, the inkjet printer 10B is described as a line printer, and the raster is described as being formed by liquid droplets ejected from a plurality of nozzles provided at positions spaced apart along the transport direction of the medium P. In contrast, in a so-called serial printer in which the print head moves forward and backward in the width direction of the medium P, a liquid droplet may be similarly ejected at the pixel preceding the on-edge part even in a configuration where liquid droplets ejected from the nozzles during the forward movement and liquid droplets ejected from the nozzles during the backward movement are alternately arranged to form a raster. Alternatively, in the serial printer, a similar technique can be applied in the case of an interlace or the like where the print head is moved forward and backward a plurality of times to form a raster through a plurality of paths. In either case, the occurrence of a phenomenon in which the landing position of the liquid droplet at the on-edge part shifts, causing a drop in the image quality, can be suppressed.

### C. Third Embodiment

The inkjet printer 10C according to the third embodiment will now be described. The inkjet printer 10C according to the third embodiment ejects only one kind of liquid droplets without distinguishing small, medium, and large liquid droplets. That is, the number of tone levels that can be expressed is two, that is, whether there is a dot or no dot. Therefore, the dot data sent from the host computer 90 is also configured as data representing whether there is a dot or no dot of each color.

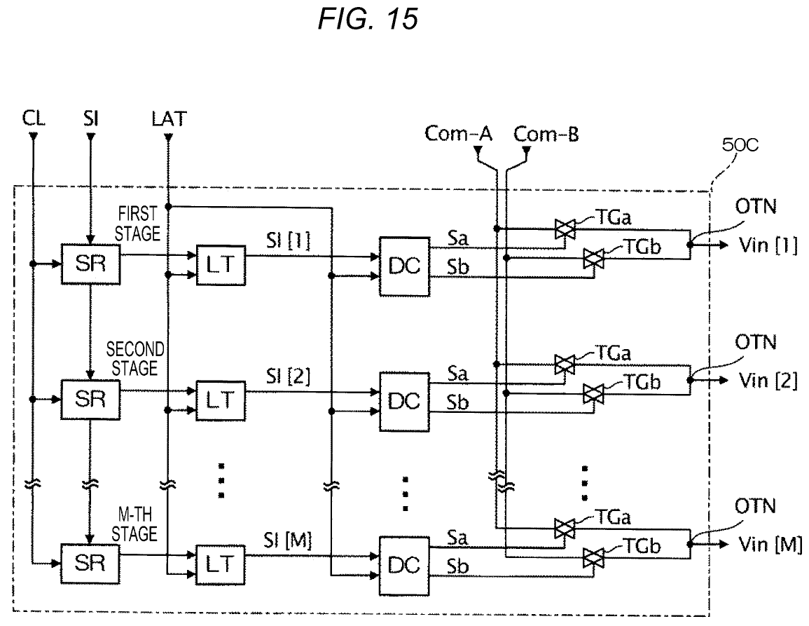

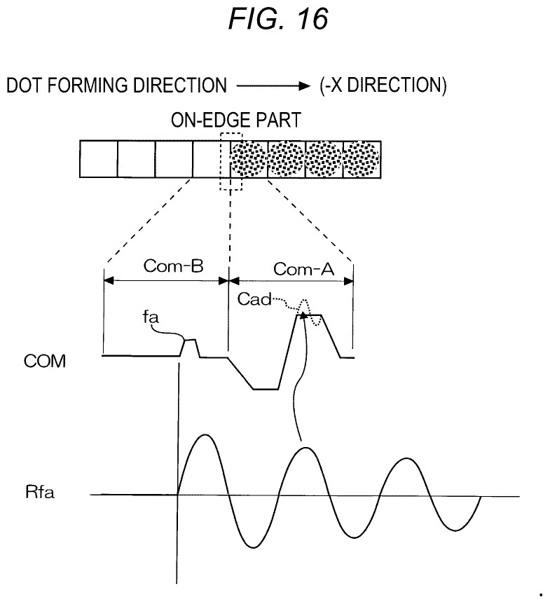

FIG. 15 illustrates the configuration of a drive signal output unit 50C of the inkjet printer 10C according to the third embodiment. As illustrated, unlike the drive signal output unit 50 in the first embodiment, the drive signal output unit 50C receives an input of two types of waveforms, that is, a first drive waveform signal Com-A and a second drive waveform signal Com-B, as the drive waveform signal COM. The first drive waveform signal Com-A is a waveform that enables ejection of a liquid droplet corresponding to a large dot. Meanwhile, the second drive waveform signal Com-B is not a voltage waveform that causes a deformation of the multilayer piezoelectric element 201 that is large enough to be able to eject a liquid droplet, and includes a voltage waveform fa that generates a pressure change in the cavity 245 that causes vibration in the meniscus of the ink in the nozzle N but does not result in the ejection of a liquid droplet, as shown in FIG. 16. The voltage of which of the first drive waveform signal Com-A and the second drive waveform signal Com-B is applied to the multilayer piezoelectric element 201 depends on which of the latch outputs Sa, Sb output from the decoder DC is active, as shown in FIG. 15. The latch output Sa and the latch output Sb are signals that become exclusively active.

When the dot data sent from the host computer 90 indicates that a dot is to be formed at a pixel, the latch output Sa of the corresponding decoder DC becomes active, and when a dot is not to be formed at a pixel, the latch output Sb of the corresponding decoder DC becomes active. Therefore, the second drive waveform signal Com-B is output for up to the pixel preceding the on-edge part in the raster, and the first drive waveform signal Com-A is output from the pixel immediately after the on-edge part onward. Also, in response to the pixel at which a dot is not formed, image processing may be performed in such a way as to output a drive waveform signal which does not result in the formation of a liquid droplet and which generates smaller micro-vibration than the micro-vibration by the second drive waveform signal Com-B, and to output the second drive waveform signal Com-B only at the pixel preceding the on-edge part.

In any case, since the pressure corresponding to the waveform fa is applied to the ink inside the cavity 245 though a liquid droplet is not ejected at the pixel preceding the on-edge part, the meniscus of the ink also vibrates in accordance with the pressure change in the nozzle N. As illustrated, this residual vibration Rfa is generated from the time point when the voltage of the waveform fa included in the second drive waveform signal Com-B is applied, and continues for a predetermined period while being damped. Since the waveform of the second drive waveform signal Com-B is defined in such a way that the peak of the residual vibration coincides with the peak in the first drive waveform signal Com-A output at the pixel immediately after the on-edge part, a pressure change Cad due to the residual vibration is added to the pressure change inside the cavity 245 due to the deformation of the multilayer piezoelectric element 201. As a result, the ejection performance of the liquid droplets ejected from the nozzle N changes. In the third embodiment, particularly the ejection speed, of the ejection performances, is high. The ejection speed at this time is substantially the same as the ejection speed when the first drive waveform signal Com-A continues, that is, when dots are consecutively formed. This is because even when the first drive waveform signal Com-A continues, residual vibration occurs due to the ejection of a liquid droplet and increases the ejection speed of the subsequent liquid droplet.

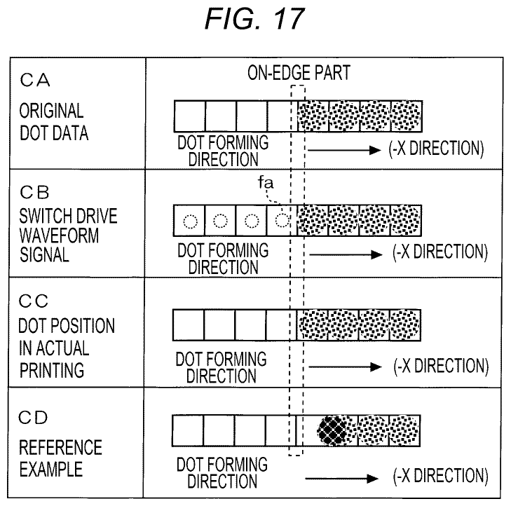

The state of the dot formation in the third embodiment is illustrated in FIG. 17. In the illustration, a section CA shows original dot data. The state where the drive waveform signal is switched according to the original dot data is shown in a section CB. The symbol fa in the illustration indicates that micro-vibration corresponding to a waveform in the second drive waveform signal Com-B occurs. There is no ejection of liquid droplets due to the micro-vibration based on the waveform fa.

A section CC shows a visualized sample of dots actually formed on the medium P. No dot is formed at each pixel up to the on-edge part, but micro-vibration is generated in the meniscus of the ink in the nozzle N. Therefore, when a voltage of a drive waveform signal that is high enough to eject a liquid droplet is output at the pixel immediately after the on-edge part, the multilayer piezoelectric element 201 generates a pressure change in the cavity 245 that is large enough to eject a liquid droplet due to a voltage change obtained by adding the micro-vibration generated by the drive waveform signal at the immediately preceding pixel. As a result, liquid droplets are ejected without being delayed in relation to the pixel positions, and dots are thus formed. An example of a dot formed when a drive waveform signal that does not include the waveform fa is output at each pixel up to the on-edge part is shown as a reference example in a section CD, and in this case, the waveform fa is not included in the drive signal corresponding to each pixel up to the on-edge part and therefore micro-vibration and residual vibration due to micro-vibration do not occur. Therefore, the ejection speed of the liquid droplet ejected from the pixel immediately after the on-edge part drops and the landing position of the liquid droplet shifts to the rear. As a result, the position of the dot to be formed at the on-edge part shifts and the image quality drops. In contrast, in the third embodiment, such deterioration in the image quality does not occur.

### D. Other Embodiments

(1) The printing device can be implemented according to the following aspect. The printing device includes: a head including an ejection unit that ejects a liquid droplet and forms a dot on a medium in response to a drive element driven by a drive signal; a print position changing unit that changes a relative positional relationship between the medium and the head along a predetermined direction; a signal output unit that selectively outputs, to the drive element, the drive signal for ejecting the liquid droplet under ejection conditions with different ejection capabilities from the ejection unit; and a control unit that controls the print position changing unit and the signal output unit to control the ejection of the liquid droplet from the ejection unit toward the medium according to a dot-forming pixel and a non-dot-forming pixel arranged along the predetermined direction. At an on-edge part where the dot-forming pixel comes next to the non-dot-forming pixel along the predetermined direction, the drive signal at a position corresponding to the non-dot-forming pixel is set to be a drive signal smaller than a signal corresponding to a maximum ejection capability that can be achieved at the dot-forming pixel and larger than a signal at the non-dot-forming pixel, and is thus output to the drive element.

Thus, since the drive signal at the position corresponding to the non-dot-forming pixel is set to be a drive signal smaller than the signal corresponding to the maximum ejection capability that can be achieved at the dot-forming pixel and larger than the signal at the non-dot-forming pixel, and is thus output to the drive element, the problem of the shift in the actual dot formation at the dot-forming pixel into a predetermined direction, causing a drop in the image quality, can be avoided. The drive signal at this time may be a drive signal smaller than the signal corresponding to the maximum ejection capability that can be achieved at the dot-forming pixel and larger than the signal at the non-dot-forming pixel, and a dot may be formed or may not be formed, based on this drive signal. When a dot is formed, since the drive signal is smaller than the signal corresponding to the maximum ejection capability that can be achieved at the dot-forming pixel, if a large dot can be formed at the dot-forming pixel, the drive signal may be adjusted in such a way that a smaller dot, for example, a medium dot or a small dot is formed. In practice, the drive signal may be directly controlled, or the dot data of a large dot may be replaced with the dot data of a medium dot or a small dot and the drive signal may be output according to the dot data. Since the drive signal is a drive signal larger than the signal at the non-dot-forming pixel, even when no dot is formed, the driving of the drive element influences the ink and the fluidity of the ink increases, and therefore the delay in the ejection of a liquid droplet at the on-edge part is reduced and the positional shift of the on-edge part is reduced, thus suppressing a drop in the image quality.

In such a printing device, the relative positional relationship of the head to the medium on which ink dots are formed by the ejected liquid droplets is changed along the predetermined direction, and therefore a line printer, a serial printer, a plotter, or the like is employed. The printing by the printing device is assumed to be monochrome printing performed using a single-color (in many cases, black) ink or color printing performed using inks of a plurality of hues. The monochrome printing includes printing that uses a gray ink in addition to a black ink. The color printing includes printing that uses special color inks such as RGB or light-colored inks such as light cyan (LC) and light magenta (LM) in addition to the CMYK inks.

In a line printer, the print position changing unit is generally configured to move the medium in relation to the head. In a serial printer, the head may be moved in the width direction of the medium, or the medium may be moved in relation to the head. Also, both may be moved relatively to each other. In a plotter in which the head is two-dimensionally movable in relation to a printing surface of the medium, a configuration in which the head is moved is employed in general. The print position changing unit changes the print position, using an actuator such as a motor, but may employ a configuration in which the rotation of the motor is converted into a movement in a predetermined direction via an endless belt or the like, or may employ a configuration in which a movement in a predetermined direction can be made from the beginning by a linear motor or the like. To move the medium, a configuration in which the medium is held between and transported by rollers or the like rotated by the motor is employed in general, but a configuration in which the medium is rolled up may be employed. Also, the medium may be transported by a linear motor or the like.

The signal output unit selectively outputs, to the drive element, the drive signal for ejecting liquid droplets under ejection conditions with different ejection capabilities from the ejection unit, and when the drive element is an electrostrictive element, the signal output unit may employ a circuit configuration to output a voltage signal for causing a distortion of the electrostrictive element. When the drive element is a heater that forms bubbles in a liquid such as ink and thus ejects the ink, a circuit configuration to supply power for heating the heater may be employed. When a drive element is prepared for each of a plurality of ejection units, circuits for separately outputting drive signals of a predetermined drive waveform to the plurality of drive elements may be prepared. Alternatively, a circuit that collectively handles drive waveforms for determining the operations of the plurality of drive elements and a circuit that determines the on/off of the driving of a drive element, based on the on/off of the dot formation, may be combined, and when the dot formation is on, a drive signal having a predetermined drive waveform may be output to the drive element.

The control unit controls the print position changing unit and the signal output unit and thus controls the ejection of liquid droplets from the ejection unit toward the medium according to the dot-forming pixel and the non-dot-forming pixel arranged along the predetermined direction. Such control may be implemented by dedicated hardware, a dedicated ASIC, or the like, or may be implemented by program processing using a CPU.

In the printing device, at an on-edge part where a dot-forming pixel comes next to a non-dot-forming pixel along a predetermined direction, a drive signal at a position corresponding to the non-dot-forming pixel is set to be a drive signal smaller than a signal corresponding to the maximum ejection capability that can be achieved at the dot-forming pixel and larger than a signal at the non-dot-forming pixel, using the print position changing unit and the signal output unit, and this drive signal is output to the drive element. The control of the drive signal may be implemented by the hardware of the signal output unit or may be implemented by modifying the dot data for determining whether to eject liquid droplets.

(2) In the above configuration, the ejection capability may include at least a capability related to a size of a liquid droplet, and the drive signal output at the non-dot-forming pixel may be a drive signal for ejecting a liquid droplet having a smaller dot size than a dot formed at the dot-forming pixel in the on-edge part. In this way, since a liquid droplet having a smaller dot size than the dot formed at the dot-forming pixel is ejected at the non-dot-forming pixels in the on-edge part, the problem of the shift in the forming position of the dot at the on-edge part to the rear in the predetermined direction, causing a shift in the position of the one-edge part and a drop in the image quality, can be suppressed. Also, since the dot size formed at the non-dot-forming pixel is smaller than the dot formed at the dot-forming pixel in the on-edge part, the change in the image quality is suppressed further. When the control to eject liquid droplets corresponding to ink dots of a plurality of types of sizes such as large and small dots or large, medium, and small dots is performed in the first place in order to form an image, a liquid droplet corresponding to the small dot or the medium dot may be ejected as the liquid droplet having a smaller dot size than the dot formed at the dot forming pixel. When only the control about whether to form a dot by ejecting or not ejecting a liquid droplet is performed, control such that the drive signal is switched to a drive signal for ejecting a small liquid droplet only when ejecting a liquid droplet at the non-dot-forming pixel in the on-edge part may be performed.

(3) In the above configuration, the drive signal output at the dot-forming pixel may be a drive signal for ejecting a liquid droplet having a smaller dot size than at a dot-forming pixel outside the on-edge part. Thus, the density change due to the formation of a dot at the non-dot-forming pixel, at which a dot is not originally supposed to be formed, can be suppressed by reducing the size of the dot at the dot-forming pixel, and the deterioration in the image quality at the on-edge part can be suppressed further.

(4) In the configuration of (3), the drive signal output at the dot-forming pixel may be a drive signal for ejecting a liquid droplet having a larger dot size than at the non-dot-forming pixel. Thus, the dot size formed at the on-edge part has the relationship of the dot at the non-dot-forming pixel <the dot at the dot-forming pixel <the dot at the dot-forming pixel outside the on-edge part, and therefore the deterioration in the image quality at the on-edge part is suppressed further.

(5) In the configuration of (1), the ejection capability may include at least a capability related to a size of a liquid droplet, and the drive signal output at the dot-forming pixel may be a drive signal for ejecting a liquid droplet having a smaller dot size than at a dot-forming pixel outside the on-edge part. Thus, the density change due to the formation of a dot at the non-dot-forming pixel, at which a dot is not originally supposed to be formed, can be suppressed by reducing the size of the dot at the dot-forming pixel, and the deterioration in the image quality at the on-edge part can be suppressed.

(6) In each of the above configurations, the printing device may form at least one raster, which is an array of pixels along the predetermined direction, by ejecting the liquid droplets from Q ejection units, Q being an integer equal to or greater than 2, or by ejecting the liquid droplets through Q scans with the head, and the drive signal may be output according to whether to form the dot at an interval of Q-1 dots as a pixel position, and a part where the dot-forming pixel comes next to the non-dot-forming pixel in an array of pixels at the interval of Q-1 may be regarded as the on-edge part. Thus, even in bidirectional printing in which one raster is completed by a forward movement and a backward movement, or interlace printing in which one raster is completed by two or more scans, the deterioration in the image quality at the on-edge part can be similarly suppressed. Such printing for completing one raster by a plurality of scans is not limited to a serial printer and may also be performed by a line printer. In this line printer, one raster is formed by ejecting liquid droplets from a plurality of different ejection units.

(7) In the above configuration, the ejection capability may include at least a capability related to an ejection speed of a liquid droplet, and the drive signal output prior to the ejection of the liquid droplet may include a vibration generating waveform that synchronizes a phase of residual vibration in the ejection unit with vibration in the ejection unit based on a waveform of the drive signal output at the dot-forming pixel and thus increases the ejection speed of the liquid droplet at the dot-forming pixel. Thus, since the ejection speed, of the ejection performances of the liquid droplets ejected at the on-edge part, is increased, the problem of the delay of the landing of the liquid droplet on the medium, causing the boundary between the non-dot-forming pixel and the dot-forming pixel to move to the rear in the predetermined direction, and thus causing a drop in the image quality, can be suppressed.

(8) In the above configuration, the vibration generating waveform may be a waveform that is not large enough to eject a liquid droplet from the ejection unit and that generates residual vibration in the ejection unit, and the phase of the residual vibration may increase the ejection speed of the liquid droplet at the dot-forming pixel in synchronization with the vibration in the ejection unit based on the waveform of the drive signal output at the dot-forming pixel. Thus, since a liquid droplet is not ejected depending on the vibration generating waveform, extra ink dots are not formed on the medium.

(9) The present disclosure can be implemented in the form of a printing method. The printing method includes: changing a relative positional relationship between a head including an ejection unit that ejects a liquid droplet and forms a dot on a medium in response to a drive element driven by a drive signal and the medium along a predetermined direction; outputting, to the drive element, a signal for ejecting the liquid droplet under different ejection conditions from the ejection unit, with the change in the positional relationship, and forming a dot based on the liquid droplet on the medium; and at an on-edge part where a dot-forming pixel at which the dot is generated comes next to a non-dot-forming pixel at which the dot is not formed on the medium, along the predetermined direction, setting the drive signal at a position corresponding to the non-dot-forming pixel to be a drive signal smaller than a signal corresponding to a maximum ejection capability that can be achieved at the dot-forming pixel and larger than a signal at the non-dot-forming pixel, and outputting this drive signal to the drive element. Thus, the problem of the shift in the position of the ink dot formed at the on-edge part to the rear in the predetermined direction can be suppressed. Therefore, printing in which the shift in the forming position of the ink dot is suppressed and in which the drop in the image quality is suppressed can be performed.

(10) The present disclosure can be implemented in the form of an image processing method. The image processing method is for a printing device which changes a relative positional relationship between a head including an ejection unit that ejects a liquid droplet and forms a dot on a medium in response to a drive element driven by a drive signal and the medium along a predetermined direction, the method preparing dot data that defines whether to form the dot, the method including: inputting image data of an image to be reproduced on the medium; converting the image data into dot data formed by distributing dots corresponding to a number of tone levels that can be formed by the head; and modifying the dot data in such a way that, at an on-edge part where a dot-forming pixel at which the dot is formed comes next to a non-dot-forming pixel at which the dot is not formed in an array of the dots along the predetermined direction included in the dot data, a dot smaller than a largest dot that can be formed at the dot-forming pixel is formed at the non-dot-forming pixel. Thus, the dot data converted from the image data representing the image can be configured in such a way that the drop in the image quality at the on-edge part can be suppressed. As a result, the printing device or the like need not perform processing to suppress the drop in the image quality.

(11) In the above-described embodiments, a part of the configuration implemented by hardware may be replaced with software. At least a part of the configuration implemented by software can be implemented by a discrete circuit configuration. When a part or all of the functions according to the present disclosure are implemented by software, the software (computer program) can be provided in the form of being stored in a computer-readable medium. The “computer-readable medium” is not limited to a portable medium such as a flexible disc or a CD-ROM, and includes internal storage devices in a computer such as various RAMs and ROMs or an external storage device fixed to a computer such as a hard disk. That is, the term “computer-readable medium” has a broad meaning including any medium in which a data packet can be fixed, not temporarily.

The present disclosure is not limited to the above embodiments and may be implemented with various configurations without departing from the spirit and scope of the present disclosure. For example, technical features in the embodiments corresponding to technical features in the aspects described in the summary section can be replaced and combined as appropriate in order to solve a part or all of the above problems or in order to achieve a part or all of the above effects. The technical feature can be deleted where appropriate, unless described as essential in the present specification.

What is claimed is:

1. A printing device comprising:
a head including an ejection unit that ejects a liquid droplet and forms a dot on a medium in response to a drive element driven by a drive signal;
a print position changing unit that changes a relative positional relationship between the medium and the head along a predetermined direction;
a signal output unit that selectively outputs, to the drive element, the drive signal for ejecting the liquid droplet under ejection conditions with different ejection capabilities from the ejection unit; and
a control unit that controls the print position changing unit and the signal output unit to control the ejection of the liquid droplet from the ejection unit toward the medium according to a dot-forming pixel and a non-dot-forming pixel arranged along the predetermined direction, wherein
at an on-edge part where the dot-forming pixel comes next to the non-dot-forming pixel along the predetermined direction, the drive signal at a position corresponding to the non-dot-forming pixel is set to be a drive signal smaller than a signal corresponding to a maximum ejection capability that can be achieved at the dot-forming pixel and larger than a signal at the non-dot-forming pixel, and is thus output to the drive element.

2. The printing device according to claim 1, wherein
the ejection capability includes at least a capability related to a size of a liquid droplet, and
the drive signal output at the non-dot-forming pixel is a drive signal for ejecting a liquid droplet having a smaller dot size than a dot formed at the dot-forming pixel in the on-edge part.

3. The printing device according to claim 2, wherein
the drive signal output at the dot-forming pixel is a drive signal for ejecting a liquid droplet having a smaller dot size than at a dot-forming pixel outside the on-edge part.

4. The printing device according to claim 3, wherein
the drive signal output at the dot-forming pixel is a drive signal for ejecting a liquid droplet having a larger dot size than at the non-dot-forming pixel.

5. The printing device according to claim 1, wherein
the ejection capability includes at least a capability related to a size of a liquid droplet, and
the drive signal output at the dot-forming pixel is a drive signal for ejecting a liquid droplet having a smaller dot size than at a dot-forming pixel outside the on-edge part.

6. The printing device according to claim 1, wherein
the printing device forms at least one raster, which is an array of pixels along the predetermined direction, by ejecting the liquid droplets from Q ejection units, Q being an integer equal to or greater than 2, or by ejecting the liquid droplets through Q scans with the head,
the drive signal is output according to whether to form the dot at an interval of Q-1 dots as a pixel position, and
a part where the dot-forming pixel comes next to the non-dot-forming pixel in an array of pixels at the interval of Q-1 is regarded as the on-edge part.

7. The printing device according to claim 1, wherein
the ejection capability includes at least a capability related to an ejection speed of a liquid droplet, and
the drive signal output prior to the ejection of the liquid droplet includes a vibration generating waveform that synchronizes a phase of residual vibration in the ejection unit with vibration in the ejection unit based on a waveform of the drive signal output at the dot-forming pixel and thus increases the ejection speed of the liquid droplet at the dot-forming pixel.

8. The printing device according to claim 7, wherein
the vibration generating waveform is a waveform that is not large enough to eject a liquid droplet from the ejection unit and that generates residual vibration in the ejection unit, and
the phase of the residual vibration increases the ejection speed of the liquid droplet at the dot-forming pixel in synchronization with the vibration in the ejection unit based on the waveform of the drive signal output at the dot-forming pixel.

9. A printing method comprising:
changing a relative positional relationship between a head including an ejection unit that ejects a liquid droplet and forms a dot on a medium in response to a drive element driven by a drive signal and the medium along a predetermined direction;
outputting, to the drive element, a signal for ejecting the liquid droplet under different ejection conditions from the ejection unit, with the change in the positional relationship, and forming a dot based on the liquid droplet on the medium; and
at an on-edge part where a dot-forming pixel at which the dot is generated comes next to a non-dot-forming pixel at which the dot is not formed on the medium, along the predetermined direction, setting the drive signal at a position corresponding to the non-dot-forming pixel to be a drive signal smaller than a signal corresponding to a maximum ejection capability that can be achieved at the dot-forming pixel and larger than a signal at the non-dot-forming pixel, and outputting this drive signal to the drive element.

10. An image processing method for a printing device which changes a relative positional relationship between a head including an ejection unit that ejects a liquid droplet and forms a dot on a medium in response to a drive element driven by a drive signal and the medium along a predetermined direction, the method preparing dot data that defines whether to form the dot, the method comprising:
inputting image data of an image to be reproduced on the medium;
converting the image data into dot data formed by distributing dots corresponding to a number of tone levels that can be formed by the head; and
modifying the dot data in such a way that, at an on-edge part where a dot-forming pixel at which the dot is formed comes next to a non-dot-forming pixel at which the dot is not formed in an array of the dots along the predetermined direction included in the dot data, a dot smaller than a largest dot that can be formed at the dot-forming pixel is formed at the non-dot-forming pixel.
